(19) United States
(12) Patent Application Publication
(10) Pub. No.: US 2014/0233213 A1
(43) Pub. Date: Aug. 21, 2014

(54) LED LIGHT SYSTEM WITH VARIOUS LUMINESCENT MATERIALS

(71) Applicants: Joerg Frischeisen, Schwabmuenchen (DE); Frank Jermann, Koenigsbrunn (DE); Stefan Lange, Augsburg (DE)

(72) Inventors: Joerg Frischeisen, Schwabmuenchen (DE); Frank Jermann, Koenigsbrunn (DE); Stefan Lange, Augsburg (DE)

(73) Assignee: OSRAM GmbH, Muenchen (DE)

(21) Appl. No.: 14/347,248

(22) PCT Filed: Aug. 28, 2012
(86) PCT No.: PCT/EP2012/066691

§ 371 Date: Mar. 26, 2014

(30) Foreign Application Priority Data
Sep. 27, 2011 (DE) 10 2011 083 564.4

(51) Int. Cl. F21K 99/00

(52) U.S. Cl. CPC F21K 9/56
USPC 362/84

(57) ABSTRACT

An LED light system may include a primary LED radiation source, in particular at least one blue- or UV-emitting semiconductor element, wherein a first dome of transparent or translucent material, which acts as a conversion element, is placed in front of the primary light source in the emission direction, wherein at least a part of the surface of the first dome is divided into at least two regions of different types, which comprise luminescent materials, the at least two regions including different luminescent materials for the conversion.

### RELATED APPLICATIONS

The present application is a national stage entry according to 35 U.S.C. §371 of PCT application No. PCT/EP2012/066691 filed on Aug. 28, 2012, which claims priority from German application No.: 10 2011 083 564.4 filed on Sep. 27, 2011, and is incorporated herein by reference in its entirety.

### TECHNICAL FIELD

Various embodiments relate to an LED light system. Various embodiments furthermore relate to an associated unit, a module or light, including such an LED light system.

### BACKGROUND

An LED light source, in which a dome that contains luminescent material is arranged over an LED array, is previously known from U.S. Pat. No. 7,758,223.

WO 2009/068262 discloses an LED light source having a dome, wherein separate surfaces for different luminescent materials are provided. However, the overall structure is very complicated.

### SUMMARY

Various embodiments provide an improved concept for an LED light system. Various embodiments furthermore provide an LED light system, in particular an LED-based light source, for example an LED retrofit lamp, the efficiency of which is improved.

LED light sources, in particular LED retrofit lamps, are nowadays standardly produced with an LED array, a particular number of white LEDs, which is mounted on a printed circuit board. One conventional embodiment is that the wavelength conversion of a blue-emitting LED chip based on InGaN, which is required in order to generate white light, takes place in the LED and therefore close to the chip. Typically, the conversion element containing the luminescent material or materials is applied directly on the chip.

In another embodiment of an LED light source, the so-called “remote phosphor” concept, conversely, the luminescent material is arranged spatially clearly separated from the blue LEDs. Depending on the embodiment, the distance is typically from 0.5 to 10 cm, in particular from 1.5 to 5 cm. In this context, an embodiment having a dome-shaped conversion element, here often referred to as an inner dome, with simple geometry, for example a sphere segment of constant shell thickness, within a diffuse outer lamp bulb, as well as embodiments in which the luminescent material is applied directly on the transparent outer bulb, are prior art.

According to various embodiments, a configuration of an LED light source having an improved conversion element is provided. In this context, the following points are important:

Various embodiments relate to LED light sources, above all lamps/lights, which are based on the partial conversion of light of LEDs by a luminescent material layer, that is to say they include a conversion element. The luminescent material layer is in this case configured as a “remote phosphor element” (for example as a kind of dome or plate over the LEDs), that is to say the LEDs and the luminescent material are spatially separated from one another. The remote phosphor element is in this case intended to convert light (for example blue light) into longer-wavelength light (for example yellow or yellow-Fred light), so that overall a particular color impression (for example white) is formed.

The remote phosphor element may additionally be enclosed by a (diffuse) outer shell (for example made of plastic with scatters such as TiO₂ or Al₂O₃), which can lead to more homogeneous light mixing in the far field. The remote phosphor element may furthermore consist of a plurality of segments.

The size of the remote phosphor element should in this case be selected so that the element is not heated too greatly (otherwise, an inferior conversion efficiency of the luminescent material and stability problems of the remote phosphor element are possible). In general, a higher radiation dose, more scattering/absorption in the element, and a smaller surface/volume ratio of the element lead to greater heating.

In principle, a plurality of embodiments are possible:

| | | Luminescent |
|---|---|---|
| | | material(s) in the |
| | | remote phosphor |
| Embodiment | LED(s) | element |
| “Warm white” | At least one type | A plurality (for |
| | (for example blue) | example yellow and |
| | | red) |
| “Maggie” | A plurality of types | At least one (for |
| | (for example blue | example yellow) |
| | and red) | |
| “Hybrid remote” | A plurality of types | At least one (for |
| | (for example blue | example yellow) |
| | and magenta; magenta = | |
| | blue chip with | |
| | near-chip red | |
| | conversion (for | |
| | example CLC or VC) | |

In general, only one type of remote phosphor element, below which the LEDs are fitted, is used in all three variants. This has the following disadvantages for the different variants:

| Variant | Disadvantage |
|---|---|
| Warm white | Interactions between the luminescent materials |
| | in the remote phosphor element, that is to say a |
| | plurality of luminescent materials in the |
| | element, lead to more scattering, more |
| | absorption and therefore to greater heating of |
| | the element, which in turn leads to a lower |
| | stability and lower conversion efficiency. |
| | Accurate control of the concentrations of the |
| | two luminescent materials in the remote phosphor |
| | element is necessary. |
| Maggie/hybrid | The light of the longer-wavelength (for example |
| remote | red or magenta) LEDs has to pass through the |
| | remote phosphor element, which leads to losses |
| | due to scattering/absorption and heats the |
| | remote phosphor element. |

As a solution to the problem, various embodiments propose spatial separation of the various luminescent materials in the remote phosphor element. The curved surface of the dome improves the homogeneity of the emission in different spatial directions.

In various embodiments proposed here, the light source (for example an LED) including an inner dome is placed in front of an outer dome including scattering material, which scatters the directional light of the source substantially isotropically in all directions.

As scattering material, for example, plastics mixed with diffusers may be envisioned. Here, for example, silicone, polymethyl methacrylate (PMMA) or polycarbonate (PC) may be used as carrier material, depending on the thermal stability requirement. Aluminum oxide (Al₂O₃), titanium dioxide (TiO₂) or optionally silicon dioxide (SiO₂) may be suitable as diffusers.

The LED light source, together with the domes, is in particular placed on a cap or on another electrical and thermal connection element, here often referred to as a base element, or can be connected thereto.

Preferably, the domes are made of silicone, polycarbonate, glass, polymethyl methacrylate or translucent ceramic.

On its own or in addition to the luminescent materials for conversion, a diffuser material is incorporated into the dome; this diffuser material is preferably aluminum oxide or titanium oxide.

The luminescent material preferably used is a yellow-emitting luminescent material such as YAG:Ce, other garnets such as YaGaG or LuAG, sialons or orthosilicates, which together with a blue-emitting LED mix to form white. Nevertheless, RGB solutions with red- and green-emitting luminescent materials and blue LEDs are also possible. Furthermore, embodiments with a UV LED, particularly with blue-yellow conversion or with red-, green- and blue-emitting luminescent materials, are also possible. What is essential here is only that at least two different luminescent materials are involved. It is essential that the dome, which carries the luminescent material, is subdivided into strips oriented in a polar fashion, as may be encountered in the case of balloons for advertising purposes. At least two different types of strips are used, which are equipped with different luminescent materials.

The width, and therefore the area, of the polar strips may vary, but may also be of the same type. For example, for strips of the same type may therefore fill out the dome, with two luminescent materials, which respectively emit green and red, being used alternately. In the extreme case, however, each strip may differ in terms of width and luminescent material. Preferably, these strips are applied externally on the inner dome, although application on the outer dome is also possible. Furthermore, different types of strips, such as metal heat sinks, may also be fitted between the individual strips.

The LED array is preferably arranged in such a way that the LEDs are arranged circularly around a central point, which forms the optical axis. Optionally, an LED may also be arranged at the central point itself.

The primary light source is a semiconductor chip optionally also produced as an LED, laser diode or chip-on-board, which preferably emits UV, blue or white.

An LED light system having a primary LED radiation source, in particular at least one blue- or UV-emitting semiconductor element, is disclosed, wherein a first dome of transparent or translucent material, which acts as a conversion element, is placed in front of the primary light source in the emission direction, characterized in that at least a part of the surface of the first dome is divided into at least two regions of different types, which include luminescent materials, the at least two regions including different luminescent materials for the conversion.

In a further embodiment, the LED light system is configured such that the first dome or a further dome is equipped with a diffuser material which, in particular, is admixed with the material of the dome.

In a still further embodiment, the diffuser material is aluminum oxide, titanium dioxide or silicon dioxide, separately or as a mixture.

In a still further embodiment, the material of the first dome is plastic, glass, silicone, polymethyl methacrylate or polycarbonate.

In a still further embodiment, the radiation of the primary light source is converted partially or fully into longer-wavelength radiation by the conversion element in front of it.

In a still further embodiment, the dome is a section of an oblate body, which has an equator and a pole, the pole pointing in the direction of the optical axis.

In a still further embodiment, the regions are strip-like sectors, which are preferably oriented either in a polar fashion or parallel to the equator.

In a still further embodiment, the sectors oriented in a polar fashion have tips which meet at the pole.

In a still further embodiment, the regions are arranged on a first inner dome, the first dome either being enclosed by or enclosing a second dome.

In a still further embodiment, the second dome is equipped with diffuser material.

In a still further embodiment, the luminescent materials of a first region emit yellow to green, and the luminescent materials of a second region emit red.

In a still further embodiment, groups of regions of the same type are provided.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the disclosed embodiments. In the following description, various embodiments described with reference to the following drawings, in which:

FIG. 1 shows an LED light source, first principle;

FIG. 2 shows an LED light source, second principle;

FIG. 3 shows an LED light source, third principle;

FIG. 4 shows an embodiment of an LED lamp;

FIG. 5 shows another embodiment of an LED lamp; and

FIGS. 6 to 9 each show another embodiment of an LED lamp.

### DETAILED DESCRIPTION

The following detailed description refers to the accompanying drawing that show, by way of illustration, specific details and embodiments in which the disclosure may be practiced.

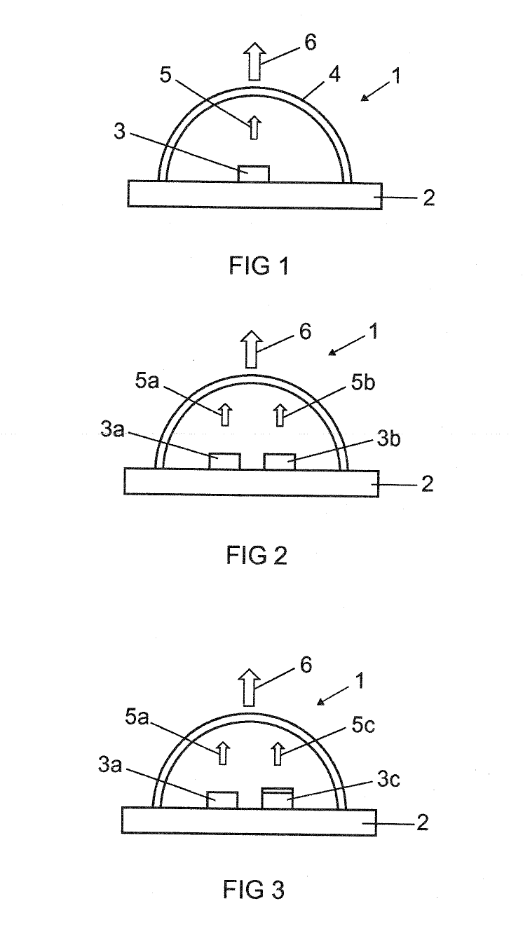

An outline embodiment of an LED light source is shown in FIGS. 1 to 3. It is a unit 1 including a semiconductor element 2, a chip or LED, on a substrate 3. A hollow body 4, which extends in the shape of a dome over the LED array, is placed on the semiconductor element 2. The hollow body 4 is for example an oblate body, or is for example an ellipsoid or a sphere segment. Spatial separation of the semiconductor element, which may also be produced using a plurality of LEDs, and the various luminescent materials in the remote phosphor element of the dome is thus provided.

Separate remote phosphor elements respectively including only one luminescent material (for example red or yellow) and excitation with (for example blue) LEDs are known. The segments may respectively also contain a plurality of luminescent materials as a mixture (for example yellow+green instead of yellow). However, it is characteristic of the solution now proposed that the dome is made up of a plurality of segments, not all segments in the dome consisting of the same luminescent material composition.

The remote phosphor element is in this case intended to convert a part or all of the primary light (for example blue light) of the semiconductor element into longer-wavelength light (for example yellow or yellow+red light), so that overall a particular color impression (for example white) is formed.

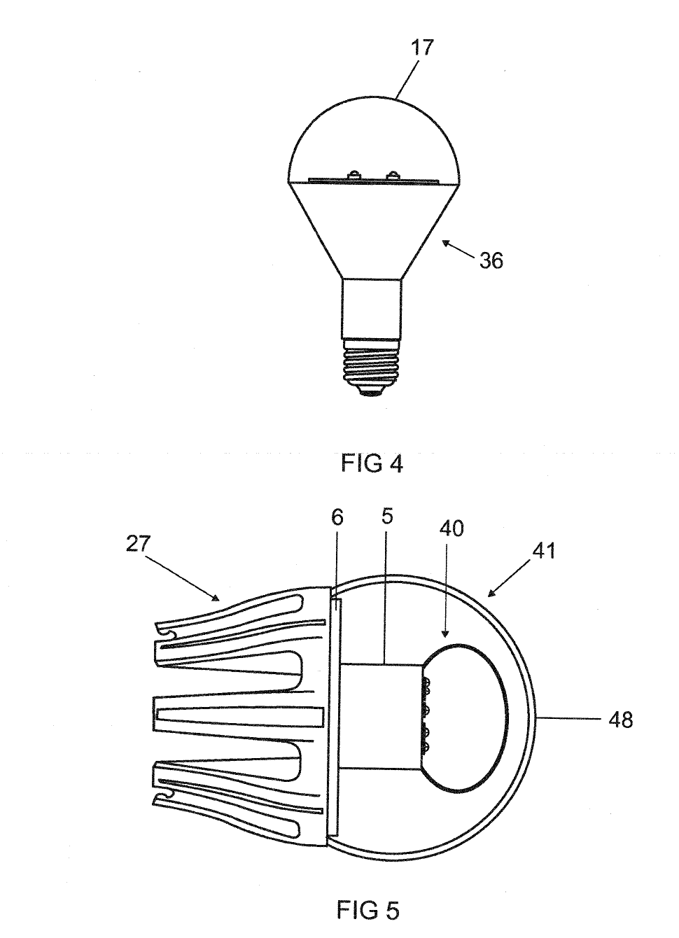

The remote phosphor element may preferably additionally be enclosed by a (diffuse) outer shell (for example made of plastic with scattering means such as TiO₂ or Al₂O₃), which can lead to more homogeneous light mixing in the far field (FIG. 4). The remote phosphor element may furthermore consist of a plurality of segments (FIG. 5).

The size of the remote phosphor element should in this case be selected so that the element is not heated too greatly (otherwise, an inferior conversion efficiency of the luminescent material and stability problems of the remote phosphor element are possible). In general, factors such as a higher radiation dose, more scattering/absorption in the element, and a smaller surface/volume ratio of the element lead to greater heating.

In principle, a plurality of embodiments are possible:

| | | Luminescent |
|---|---|---|
| | | material(s) in the |
| | | remote phosphor |
| Embodiment | LED(s) or chips | element |
| FIG. 1 “Warm white | At least one type | A plurality (for |
| concept” or RGB | (for example blue) | example yellow and |
| concept | | red) |
| FIG. 2 “Maggie | A plurality of types | At least one (for |
| concept” | (for example blue | example yellow) |
| | and red) | |
| FIG. 3 “Hybrid remote | A plurality of types | At least one (for |
| concept” | (for example blue | example yellow) |
| | and magenta; magenta = | |
| | blue chip with | |
| | near-chip red | |
| | conversion (for | |
| | example CLC or VC) | |

The LED is in this case preferably blue-emitting, a part of the radiation being converted by luminescent materials at a certain distance from the LED, so that white is formed. Alternatively, a UV LED is used, and furthermore at least two luminescent materials, which emit blue and yellow, or blue, green and red (RGB).

Specific embodiments of luminescent materials are a yellow-green-emitting garnet containing Lu and a red-emitting nitridosilicate, which are dispersed separately from one another in strip-like sectors of the wall of the oblate body.

The spatial separation offers several advantages.

Advantages of the embodiment of FIG. 1:
No interaction or less interaction of the luminescent materials, that is to say less scattering/absorption and therefore less heating, more stability and higher efficiency.
Different geometries for the various remote phosphor elements possible, so as, for example, to adjust the proportion of the respective luminescent material emission in relation to the overall emission.
No problems with the mixing of the two luminescent materials during production since the various remote phosphor elements are produced separately (although this also constitutes a disadvantage since separate processes are necessary). In this way, it is not possible for the relative ratio of, for example, red to yellow in the same element not to match (which would entail rejection).

Advantages of the embodiment of FIG. 2:
The light of the LEDs based outside does not have to pass through the remote phosphor element, that is to say the light can be output more efficiently, so that the overall efficiency of the component is increased.
Less heating of the remote phosphor element, since less light of the LEDs placed outside is scattered/absorbed by the remote phosphor element. The remote phosphor element is therefore cooler, and the conversion in the remote phosphor element is more efficient. Alternatively, by virtue of the lower heating, the size of the remote phosphor element can be reduced, which would in turn lead to lower material costs (in particular luminescent material costs).

Advantages of both embodiments:
Owing to the spatial separation, there are fewer LEDs under a remote phosphor element, that is to say the reflectivity inside the remote phosphor element is better since the LEDs have a very poor reflectivity in comparison with the rest of a board/a light engine. The efficiency of the lamp is thereby increased.

FIG. 4 shows a simple variant comprising an LED lamp 36, the semiconductor element 37 being an array consisting of a plurality of blue-emitting LEDs. The remote phosphor element is a dome 17, which at the same time contains the sectors of different luminescent materials and diffusers such as TiO₂ or Al₂O₃. In this case, only one dome is necessary.

The remote phosphor element may preferably contain only the luminescent materials, the LED lamps being additionally enclosed by a (diffuse) outer shell 48 (for example made of plastic with scattering means such as TiO₂ or Al₂O₃), which can lead to more homogeneous light mixing in the far field. The remote phosphor element is in this case the inner dome 40, which may in turn consist of a plurality of segments (FIG. 5). In detail, an exemplary embodiment of an LED light source 41 is shown, in which an LED module including blue LEDs is arranged on a platform 5 and a baseplate 6, and is equipped with an externally lying diffuser dome 48, an internally lying dome 40 including luminescent material being provided for partial conversion. In this way, particularly uniform light emission is also made possible for a remote phosphor concept.

In general the following configurations in particular may be used as a chip, or optionally as an LED or LED array, for the LED light source, or LED light system:

Blue-emitting chips as a primary light source, with partial conversion, in which at least one green-emitting and one red-emitting luminescent material is used, taking place by means of luminescent material layers on the first dome, the luminescent materials being localized on the dome; in this way, a white-emitting light source is provided,

UV LEDs as a primary light source, with partial, preferably full conversion, in which at least one yellow-emitting and one blue-emitting or at least one green-emitting, one red-emitting and one blue-emitting luminescent material is used, taking place by means of luminescent material layers on the dome, at least two of the luminescent materials being localized on the dome; in this way, a white-emitting light source is provided,

LED arrays as a primary light source, in which different types of chips that employ at least partially different luminescent materials in the region of the dome for the conversion, are used.

LED arrays as a primary light source, in which a first group of chips and a second group of chips are used, at least one group employing a plurality of luminescent materials in the region of the dome for the conversion; for example, a blue-emitting chip whose light is partially converted by luminescent materials, which are localized on the dome, into green or yellow light, together with a red-emitting, in particular amber color-emitting chip, whose light is not converted by the dome. High color rendering is thereby possible,

colored LED light systems of any type, in which for example full conversion is employed,
mood lighting, in which different types of white are generated by suitable matching of various chips and luminescent materials, for example warm white through neutral white to near-daylight white. In this case, different chips may be converted partially or fully by different luminescent materials. The absorption behavior of the various luminescent materials is specifically tailored to the emission of the different chips,
the luminescent materials respectively used may be partially or fully localized on the dome, that is to say applied thereon as a layer or introduced into the wall of the dome.

Specific embodiments of the present disclosure are:
An LED lamp with a warm white light color, in which blue-emitting LEDs, particularly with peak emission in the range of from 430 to 460 nm, are used as an LED array.
An LED lamp in which warm white is produced using a first group of blue LEDs and a second group of red LEDs, with the dome containing diffuser material and a garnet A₃B₅O₁₂:Ce, in particular containing yttrium as component A, and as a second luminescent material a garnet containing lutetium, which simultaneously contains proportions of aluminum and gallium for the component B, being introduced therein in order to generate green emission.
An LED lamp in which neutral white or cold white is produced using an array of UV LEDs, with, in addition to diffuser material, various layers of luminescent material in which there are a blue-emitting luminescent material and a yellow-emitting luminescent material, such as BAM and YAG:Ce, in two groups of sectors, being applied on the dome.

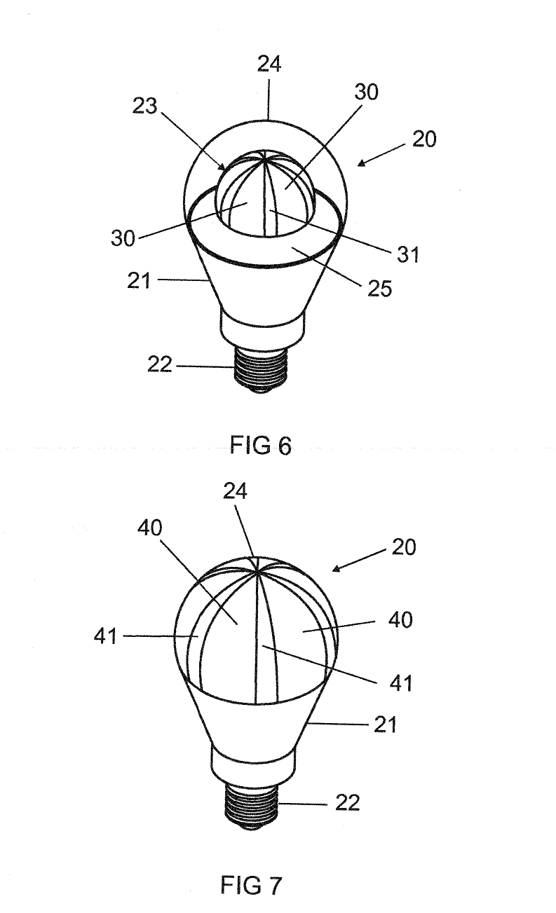

FIG. 6 shows as a light system a white-emitting LED lamp 20 comprising a base part 21, which contains electronics, a cap 22 fitted thereunder, an inner dome 23 and an outer dome 24. Blue-emitting LEDs (not visible) are introduced at the center on the base part. The inner dome 23 is equipped with first sectors 30 and second sectors 31 which are configured in the form of strips. The strips converge to a point, with all the tips touching at a pole. The first sectors 30 are coated with a luminescent material or a mixture, which converts a part of the primary radiation of the blue LEDs into yellow to green radiation. In particular, a garnet such as YAGaG:Ce or LuAGaG:Ce, or another garnet of the formula A₃B₅O₁₂:Ce, is suitable for this. The second sectors 31 are coated with a luminescent material or also a mixture thereof, which converts a part of the primary radiation of the blue LEDs into orange to red radiation. In particular, a calsin or nitridosilicate is suitable for this.

In particular, a reflector layer which improves the efficiency is applied on a collar part 25 of the base part, next to the edge 26 of the base part. Particularly preferably, the collar part 25 is produced as a circular ring.

The mixing to form white is carried out using a diffuser layer or scattering layer on an outer dome 24, which encloses both the inner dome 23 and the circular ring 25. Overall, a compact white-emitting LED lamp 20 is thereby provided.

FIG. 7 shows a similar LED lamp 20, but in which the two different sectors 41 and 42, which are configured in the form of strips and comprise different luminescent materials, are applied internally on the outer dome 24. In another exemplary embodiment, the dome 24 is preferably the only dome.

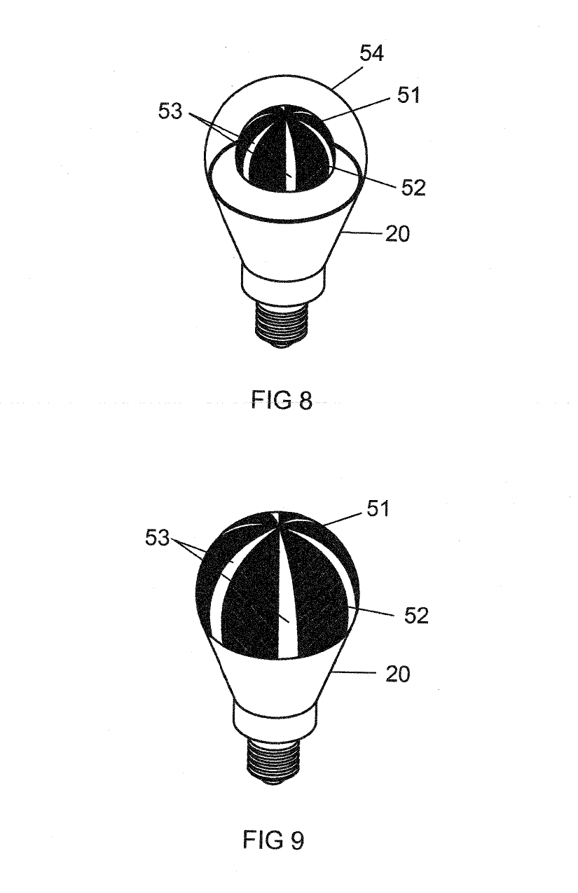

FIG. 8 shows an embodiment in which sectors 51, 52 and 53 of different width are applied on the inner dome 50 of an LED lamp 20. The outer dome 54 only includes diffusers. The group of first sectors 51 of the three different sectors may include a first luminescent material, which for example emits green. This is intended to mean that the luminescent material is applied as a layer or dispersed in the material of the dome 54. The group of second sectors 52 may include a second luminescent material, which emits red. Either the group of third sectors 53 may contain a third luminescent material, which emits for example blue or yellow, or alternatively this sector may also be used as a heat sink, in which case it includes a metallic material.

FIG. 9 shows a similar exemplary embodiment, in which once again three different groups of sectors 51, 52 and 53 are used. These, however, are applied on the outer, or only, dome 55.

In principle, it is possible for the sectors to have a different geometry. For example, instead of polar strips, strips extending parallel to the equator are also possible as sectors. Preferably, the sectors are distributed on the associated dome in such a way as to cover its surface. It is, however, also possible, for example in FIG. 8, for a group of sectors to be free of luminescent materials so that light of the primary light source passes unimpeded through the dome in this region. The various groups of sectors may alternate regularly and be present in the same number, for example from two to four sectors in a group. They may, however, also alternate irregularly and be present in different numbers, depending on the intended application.

While the disclosed embodiments have been particularly shown and described with reference to specific embodiments, it should be understood by those skilled in the art that various changes in form and detail may be made therein without departing from the spirit and scope of the disclosed embodiments as defined by the appended claims. The scope of the disclosed embodiments is thus indicated by the appended claims and all changes which come within the meaning and range of equivalency of the claims are therefore intended to be embraced.

1. An LED light system comprising a primary LED radiation source, wherein a first dome of transparent or translucent material, which acts as a conversion element, is placed in front of the primary light source in the emission direction, wherein at least a part of the surface of the first dome is divided into at least two regions of different types, which comprise luminescent materials, the at least two regions comprising different luminescent materials for the conversion.

2. The LED light system as claimed in claim 1, wherein the first dome or a further dome is equipped with a diffuser material which is admixed with the material of the dome.

3. The LED light system as claimed in claim 2, wherein the diffuser material is aluminum oxide, titanium dioxide or silicon dioxide, separately or as a mixture.

4. The LED light system as claimed in claim 1, wherein the material of the first dome is plastic, glass, silicone, polymethyl methacrylate or polycarbonate.

5. The LED light system as claimed in claim 1, wherein the radiation of the primary light source is converted partially or fully into longer-wavelength radiation by the conversion element in front of it.

6. The LED light system as claimed in claim 1, wherein the dome is a section of an oblate body, which has an equator and a pole, the pole pointing in the direction of the optical axis.

7. The LED light system as claimed in claim 6, wherein the regions are strip-like sectors, which are oriented either in a polar fashion or parallel to the equator.

8. The LED light system as claimed in claim 7, wherein the sectors oriented in a polar fashion have tips which meet at the pole.

9. The LED light system as claimed in claim 1, wherein the regions are arranged on a first inner dome, the first dome either being enclosed by or enclosing a second dome.

10. The LED light system as claimed in claim 9, wherein the second dome is equipped with diffuser material.

11. The LED light system as claimed in claim 1, wherein the luminescent materials of a first region emit yellow to green, and the luminescent materials of a second region emit red.

12. The LED light system as claimed in claim 1, wherein groups of regions of the same type are provided.

13. The LED light system as claims in claim 1, wherein the primary LED radiation source is at least one blue- or UV-emitting semiconductor element.
